(19) United States
(12) Patent Application Publication
(10) Pub. No.: US 2008/0296867 A1
(43) Pub. Date: Dec. 4, 2008

(54) Pin box assembly with torsion resistant pivot and air spring

(76) Inventors: Philip M. Bouwkamp, Bristol, IN (US); Adam W. Dexter, Elkhart, IN (US); Steve Rumsey, Three Rivers, MI (US)

Correspondence Address: DEXTER AXLE COMPANY, C/O THE GATES CORPORATION, IP LAW DEP 10-A3 1551 WEWATTA STREET, DENVER, CO, 80202, US

(21) Appl. No.: 11/809,259

(22) Filed: May 31, 2007

(51) Int. Cl. B62D 53/08

(52) U.S. Cl. 280/439

(57) ABSTRACT

A pin box assembly comprising a towing vehicle portion comprising a frame, a towed vehicle portion comprising a frame having a proximal end and a distal end, a torsion resistant pivot portion disposed between the towing vehicle portion and the towed vehicle portion, the torsion resistant pivot portion disposed at a distal end of the towed vehicle portion, the torsion resistant pivot portion comprising, a bar disposed within a tube, the tube fixedly connected to the towing vehicle portion and the bar fixedly connected to the towed vehicle portion, at least one resilient member disposed between the bar and the tube, the resilient member compressible between the bar and the tube upon a relative rotation of the tube with respect to the bar, an air spring disposed between the towing vehicle portion and the towed vehicle portion, the air spring disposed toward the proximal end of the towed vehicle portion with respect to the distal end, and a hitch pin connected to the towing vehicle portion for engaging a hitch on a towing vehicle.

### FIELD OF THE INVENTION

The invention relates to a pin box assembly, and more particularly, to a pin box comprising a torsion resistant pivot and air spring.

### BACKGROUND OF THE INVENTION

There are available numerous types of fifth wheel pin box assemblies wherein a pin on the towed vehicle is inserted into a receptacle (fifth wheel) on the towing vehicle for coupling the two vehicles. However, insofar as known, prior fifth wheel pin box assemblies did not comprise an air spring and torque tube assembly.

Representative of the art is U.S. Pat. No. 5,785,341 to Fenton which discloses a novel pneumatic isolator stabilizing assembly is provided for use with a tow vehicle and a trailer for improving ride characteristics for a driver and passengers and for minimizing the possibility of damage to the tow vehicle and the trailer. The assembly includes a frame, structure for attaching the frame to the tow vehicle, structure for attaching the frame to the trailer, and an air spring for providing a cushion between the tow vehicle and the trailer when traveling over the roads. In one embodiment, the air spring is offset from the attachment point of the frame to the trailer and in another embodiment, the air spring is generally vertically aligned with this attachment point. The frame in each embodiment includes a first subassembly fixed relative to the trailer and a second subassembly fixed relative to the tow vehicle. The subassemblies are connected together such that they can move relative to each other. The air spring is provided between the subassemblies such that when relative movement is effected in response to movement by the tow vehicle and trailer over obstructions in the road, the air spring provides a cushion between the tow vehicle and the trailer to compensate for various load conditions.

Reference is also made to Torflex® suspension axles by the Dexter Axle Company which teaches a torsion arm suspension having rubber cords disposed in a torque tube see www.dexteraxle.com/torflex axles.

Reference is also made to the 5^{th} Airborne hitch offered by Fabex as further described at www.fifthairborne.com which teaches a hitch having a pivot and an air bag.

What is needed is a pin box assembly comprising a torsion resistant pivot and air spring. The present invention meets this need.

### SUMMARY OF THE INVENTION

The primary aspect of the invention is to provide a pin box assembly comprising a torsion resistant pivot and air spring.

Other aspects of the invention will be pointed out or made obvious by the following description of the invention and the accompanying drawings.

The invention comprises a pin box assembly comprising a towing vehicle portion comprising a frame, a towed vehicle portion comprising a frame having a proximal end and a distal end, a torsion resistant pivot portion disposed between the towing vehicle portion and the towed vehicle portion, the torsion resistant pivot portion disposed at a distal end of the towed vehicle portion, the torsion resistant pivot portion comprising, a bar disposed within a tube, the tube fixedly connected to the towing vehicle portion and the bar fixedly connected to the towed vehicle portion, at least one resilient member disposed between the bar and the tube, the resilient member compressible between the bar and the tube upon a relative rotation of the tube with respect to the bar, an air spring disposed between the towing vehicle portion and the towed vehicle portion, the air spring disposed toward the proximal end of the towed vehicle portion with respect to the distal end, and a hitch pin connected to the towing vehicle portion for engaging a hitch on a towing vehicle.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a side view of the pin box.

FIG. 2 is a top view of the pin box.

FIG. 3 is a front view of the pin box.

FIG. 4 is a detail of the torque portion, namely, the torque tube and torque bar.

### DETAILED DESCRIPTION OF THE PREFERRED EMBODIMENT

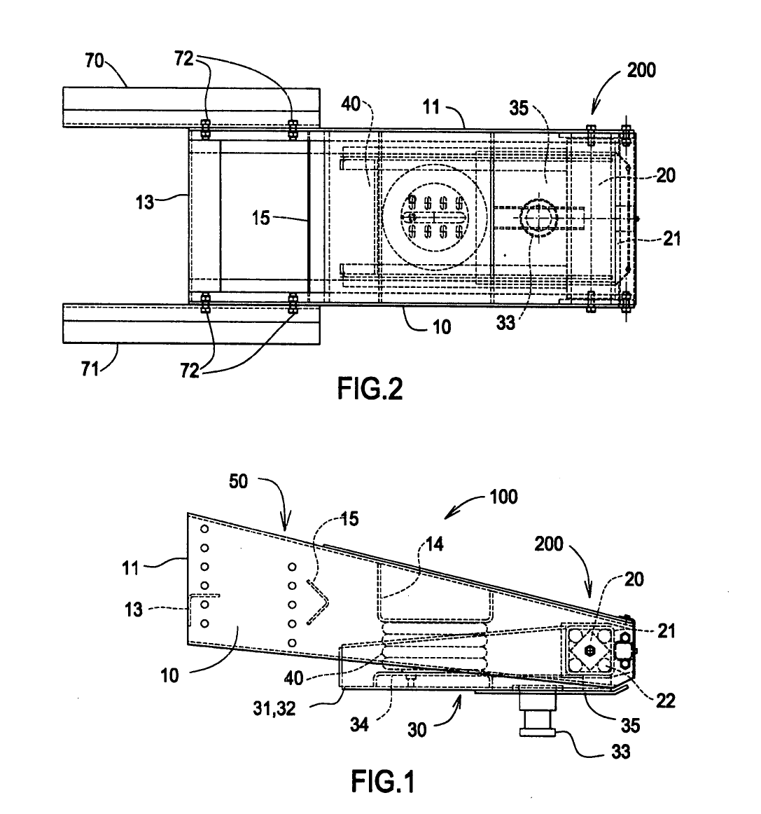

FIG. 1 is a side view of the pin box. Pin box 100 comprises frame members 10 and 11. Frame members 10, 11 are substantially parallel with frame member 13 disposed between them to form what can be referred to as a box structure. Also disposed between each frame member 10, 11 is air spring frame member 14. Air spring frame member 14 provides a first mounting surface for the air spring 40 as well as a means for reinforcing the frame members 10, 11. Frame members 10, 11 and member 13 and member 15 and air spring frame member 14 comprise what is referred to as the towed vehicle portion 50. Unless noted otherwise the components described in this specification comprise steel that are either welded or bolted together. Frame members 31, 32 are substantially parallel to each other.

Disposed at one end of portion 30 is torsion resistant pivot portion 200. Torsion resistant pivot portion 200 comprises a torque bar 20. Torque bar 20 is fixedly connected to each frame members 10, 11. Torque bar 20 is substantially square in cross-section. Portion 200 also comprises torque tube 21. Torque tube 21 is fixedly connected between frame members 31, 32. Torque tube 21 is substantially square in cross-section.

Torque bar 20 is disposed within torque tube 21. Also disposed within torque tube 21 are a plurality of resilient members 22 which reside longitudinally within the spaces between torque bar 20 and torque tube 21. In operation torque tube 21 pivots about torque bar 20. However, the torsion resistant pivot portion 200 resists pivotal movement and thereby torsion by a compression of the resilient members 22. See FIG. 4.

Pin 33 extends from hitch plate 35 on pin portion 30. Hitch plate 35 extends between and is connected to frame members 31, 32. Pin 33 is used to engage a fifth wheel hitch on a towing vehicle (not shown).

During operation the towed vehicle portion and towing vehicle portion pivot at pivot portion 200. It is known that the fifth wheel anvil (not shown) which receives pin 33 pivots in most cases as well. Pivotal movement of the towing vehicle portion 30 about pivot portion 200 allows hitch plate 35 and the fifth wheel anvil to stay in good contact as a towing vehicle is driven over varying road surfaces.

Air spring frame member 34 extends between frame members 31, 32. Air spring frame member 34 serves as a mounting surface for the air spring 40 as well as a means for reinforcing frame members 31, 32.

Frame members 31, 32, air spring frame member 34 and hitch plate 35 comprise the towing vehicle portion 30.

Air spring 40 is engaged between air spring frame member 14 and air spring frame member 34. In operation air spring 40 is compressed between air spring frame member 14 and air spring member 34. Air springs are known in the suspension arts. In the preferred embodiment the air spring comprises a Firestone® Air Bag W01-358-7564. The air spring may be connected to a vehicle air system to provide a method of automatically adjusting the suspension, or, may be filled with air using known air systems and a stem valve. The pressure in the air spring is adjustable depending upon the weight of the trailer. Other air springs that are readily available on the market may be used with equal success.

FIG. 2 is a top view of the pin box. Frame members 10, 11 are parallel to each other. Reinforcing member 15 is disposed between frame members 10, 11 and adds strength to the pin box.

Members 70, 71 are disposed on a towed vehicle such as a recreational trailer. Members 70, 71 are connected to frame members 10, 11 using fasteners known in the art such as nuts and bolts 72. Members 70, 71 may also be connected to frame members 10, 11 by welding or other suitable means.

Torque bar 20 is fixedly connected to frame members 10, 11 by welding or other suitable means.

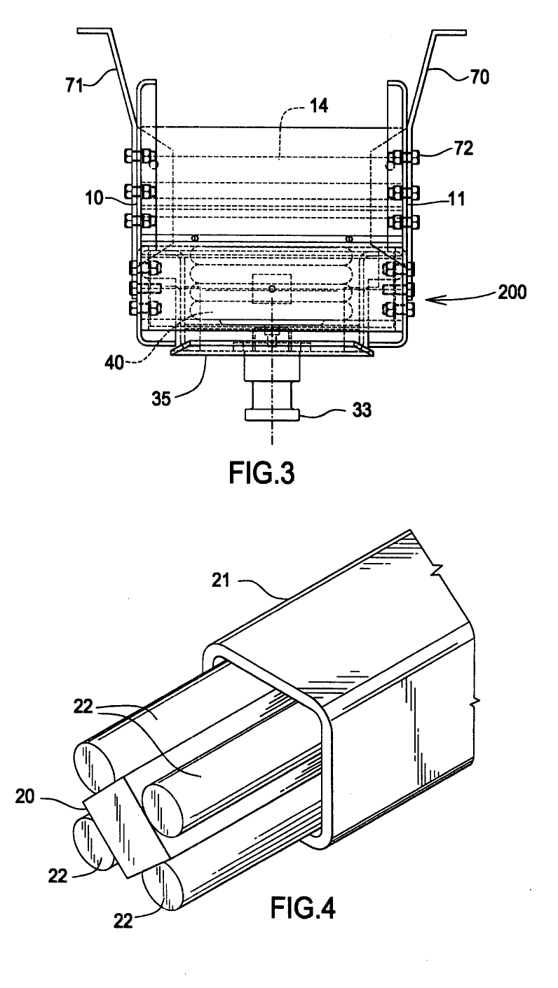

FIG. 3 is a front view of the pin box.

FIG. 4 is a detail of the torsion resistant pivot portion, namely, the torque tube and torque bar. Torque tube 20 and torque tube 21 and resilient members 22 combined comprise the torsion resistant pivot portion 200.

The pivot portion 200 operates as a hinge between the towed vehicle portion 50 and the towing vehicle portion 30. The pivot portion 200 is disposed at one end of the towing vehicle portion and the towed vehicle portion. The position of pivot portion 200 has the effect of placing air spring 40 aft of pivot portion 200. Pin 33 is on substantially the same end of the hitch as pivot portion 200. In other words, the “opening” side of the hinge, i.e. pivot portion 200, is directed in the aft direction from the towing vehicle pin 33 and toward the towed vehicle portion 50.

Resilient members 22 are arranged around the rectangular torque bar 20. Torque bar 20 and resilient members 22 are disposed within torque tube 21. Due to the rectangular shape of the torque bar 20 and torque tube 21, spaces are disposed about the torque bar 20 which are occupied by resilient members 22. In operation a force is transmitted via frame members 31, 32 to the torque tube 21 which is absorbed in part by four resilient members 22 arranged around the torque bar 20. Resilient members 22 are captured in a fixed compressed state within the torque tube 21. Compression of the resilient members 22 by pivotal movement of pivot portion 200 torsionally absorbs and dissipates the forces moving between the trailer and a towing vehicle during normal operation.

Although a form of the invention has been described herein, it will be obvious to those skilled in the art that variations may be made in the construction and relation of parts without departing from the spirit and scope of the invention described herein.

I claim:

1. A pin box assembly comprising:
a towing vehicle portion comprising a frame;
a towed vehicle portion comprising a frame having a proximal end and a distal end;
a torsion resistant pivot portion disposed between the towing vehicle portion and the towed vehicle portion, the torsion resistant pivot portion disposed at a distal end of the towed vehicle portion, the torsion resistant pivot portion comprising;
a bar disposed within a tube, the tube fixedly connected to the towing vehicle portion and the bar fixedly connected to the towed vehicle portion;
at least one resilient member disposed between the bar and the tube, the resilient member compressible between the bar and the tube upon a relative rotation of the tube with respect to the bar;
an air spring disposed between the towing vehicle portion and the towed vehicle portion, the air spring disposed toward the proximal end of the towed vehicle portion with respect to the distal end; and
a hitch pin connected to the towing vehicle portion for engaging a hitch on a towing vehicle.

2. The pin box assembly as in claim 1, wherein:
the tube has a substantially square cross-section;
the bar has a substantially square cross-section; and
a plurality of resilient members.
